(19) United States
(12) Patent Application Publication
(10) Pub. No.: US 2005/0132013 A1
(43) Pub. Date: Jun. 16, 2005

(54) Methods and systems of instant message secure client control

(75) Inventor: Christopher Kent Karstens, Apex, NC (US)

Correspondence Address: David R. Irvin;IBM Corporation, T81/503, PO Box 12195, Research Triangle Park, NC, 27709, US

(73) Assignee: International Business Machines Corporation, Armonk, NY (US)

(21) Appl. No.: 10/735,965

(22) Filed: Dec. 15, 2003

(51) Int. Cl. G06F 15/16

(52) U.S. Cl. 709/206; 709/229

(57) ABSTRACT

Methods and system for controlling the use of content over an instant message session between a source and target computer is provided. The source computer determines one or more attributes which will define the intended content controlled instant message session. The source computer sends a message containing a requested attribute to define the content controlled instant message session to the target computer. The target system determines whether it supports the requested attribute. If it does, the target computer activates a use content feature corresponding to the requested attribute and sends an acknowledgement message to the source computer. Upon receipt of the message, the source computer establishes the content controlled instant message session to limit the use of any subsequent instant message content delivered to the target computer.

### FIELD OF THE INVENTION

The present invention relates generally to improved methods and systems for instant messaging software applications, and, more particularly, to advantageous techniques for providing some level of control by a source computer over the use of instant messaging content delivered to a target computer.

### BACKGROUND OF THE INVENTION

Many personal communication options exist today. Instant messaging applications have become very popular for real time communication between users within a business enterprise, users from multiple businesses working on a business opportunity, professionals advising clients, and for all manner of personal communication. Instant messaging applications are common today over wired and wireless networks utilizing mobile devices such as pagers, personal digital assistants (PDAs), mobile phones, portable laptops, and the like, as well as non-mobile computers. A user in a business enterprise such as a brokerage house may use instant messaging to communicate with clients about whether to execute a purchase or sale of stock while also communicating within the brokerage house to develop marketing or do other strategic planning. Officers and directors of a corporation may discuss sensitive corporate issues over an instant messaging application. A lawyer might provide advice to a client. In these and many other contexts, it may be desirable or necessary to reduce the likelihood of inadvertent or other communication of information intended for one recipient to a wider audience. By way of example, to avoid loss of attorney-client privilege, it may be necessary to limit the disclosure of legal advice to a control group of individuals responsible for various aspects of a particular litigation.

Today's instant messaging applications, however, do not facilitate a limited use or distribution of content when that is desired from a source's perspective. By way of example, an instant message can be logged or captured in a variety of ways, attached to or copied into an email and sent to hundreds of recipients in a matter of minutes, if not seconds. Sometimes computer users inadvertently distribute information to an unintended audience. Occasionally, such behavior is intentional, but in any case, widespread distribution is all too easy for a wide variety of communication which is intended to be ephemeral or to be selectively distributed.

For example, from the source's perspective, an intended target of the conversation using an instant messaging application or other computer utilities such as clipboard, screen capture, printing, joining a third party into the instant message session, and the like, may extract the content discussed during an instant messaging session for later consumption by an unintended party resulting in a breach of confidence between the parties.

Clearly, methods and systems are needed to achieve instant messaging which provide a source of content better control over the use of the sent information by the intended target and potentially eliminate inadvertent misuse of such information.

### SUMMARY OF THE INVENTION

Among its several aspects, the present invention provides methods and systems for better controlling the use of content transmitted or communicated during an instant message session between a source and target computer. To this end, the source computer determines one or more attributes which will define an intended content controlled instant message session. The source computer sends to the target system a message containing the requested attribute to define the content controlled instant message session. The target system determines whether it supports the requested attribute. If it does, the target system activates the use content feature corresponding to the requested attribute and sends an acknowledgment message to the source computer. After receipt of the message, the source computer establishes the content controlled instant message session to appropriately limit the use of any subsequent instant message content generated by the source computer and delivered to the target computer as discussed in greater detail below.

Another aspect of the present invention includes techniques for verifying whether the target computer supports a content controlled instant message session, if at all. If it does not, the source computer may continue instant messaging with the target computer without use of content control or the sending user may choose to terminate the session.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates an exemplary network in which the present invention may be advantageously employed.

FIG. 2A illustrates a flow diagram for establishing a content control session between two parties without negotiation in accordance with the present invention.

FIG. 2B shows a flow diagram illustrating a failed attempt to establish a content control session between two parties with negotiation in accordance with the present invention.

FIG. 2C is a flow diagram illustrating the negotiating of attributes of an established content control session between two parties in accordance with the present invention.

FIG. 3 is a flowchart of a method in accordance with the present invention and illustrates the role of a source of content control for establishing a content control session.

FIG. 4 is a flowchart of a method in accordance with the present invention and illustrates the role of a target of content for determining whether to comply with the attributes defining a requested control session.

FIG. 5 is a flowchart of a method in accordance with the present invention and illustrates the role of a source of content upon receiving an instant message client control (IMCC) message.

FIG. 6 is a flowchart illustrating a method for evaluating and activating IMCC session attributes in accordance with the present invention.

### DETAILED DESCRIPTION

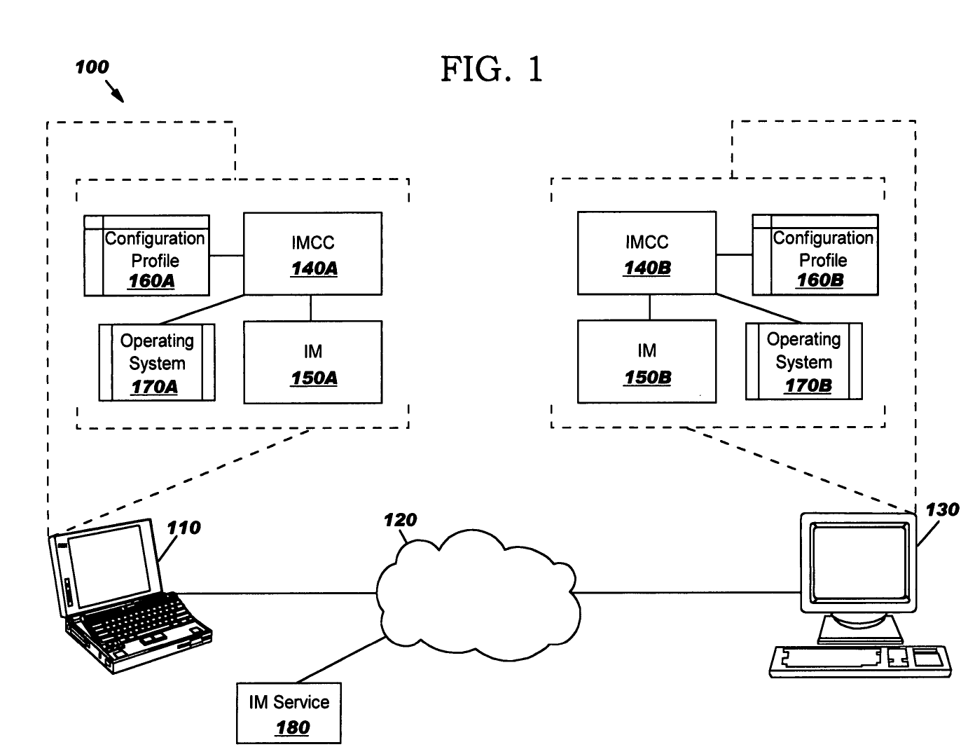

FIG. 1 shows a block diagram of an exemplary system 100 for operating a content control session within an instant messaging application. The system 100 has computers 110 and 130, a network 120, and an instant messaging (IM) service 180. The network 120 includes a local area network (LAN), a wide area network (WAN), Internet, or the like and employs a network protocol such as transaction control protocol/internet protocol (TCP/IP). The network 120 carries traffic over wired or wireless facilities. The computer 110 is connected to the IM service 180 through the network 120. A user of computer 110 typically connects to the IM service 180 by logging into the IM service 180 to which the user has subscribed and is allowed access to the IM system after the user has logged on. Similarly, computer 130 is connected to the IM service 180 through the network 120. A user of computer 130 typically connects to the IM service 180 by logging into the IM service 180 to which the user has subscribed and allows access to the IM system after the user has logged on. The computers 110 and 130 include an operating system 170A or 170B, respectively, such as AIX®, LINUX®, Windows®, or the like, and an instant messaging application 150A and 150B such as IBM Lotus Instant Messaging and Web Conferencing, America Online's Instant Messenger^{SM}, or other program code to perform the same or similar functions.

The computer 110 includes an instant messaging client control (IMCC) component comprising program code which interfaces with the IM application 150, operating system 170A, and a configuration profile 160. Further, the IMCC component may provide a user interface to allow a user to select settings which control the behavior of a content control session with another user. Computer 130 may optionally include an IMCC component 140B and a configuration profile 160B. If computer 130 includes an IMCC component 140B and configuration profile 160B, computer 130 is said to have support for participating in a content control session.

Although the computers 110 and 130 are depicted as a laptop and desktop, respectively, the computers may additionally include personal digital assistants (PDAs), mobile phones with text messaging, pagers with text messaging, or any other suitable device for instant messaging. Those of ordinary skill in the art will appreciate that the exemplary network depicted in FIG. 1 may vary, and that the depicted example is solely for illustrative purposes and is not meant to imply architectural limitations with respect to the present invention.

To provide a content control instant messaging session, a source such as a user of computer 110, for example, requests the establishment of a content control session with a target, such as a user of computer 130. For example, the user of computer 110 might select a buddy from a buddy list managed by the IM application 150A. After selecting a buddy, the IMCC component 140A determines which buddy was selected and retrieves a profile of the buddy from the configuration profile 160A, if one exists. The configuration profile 160A would contain attributes defining the content control session from the source's perspective. In other words, that profile defines the use restrictions applicable to the content that the source transmits to the target. For example, the profile may include settings which indicate whether to allow or disallow a function provided at computer 130 such as screen capture, screen printing, IM application logging, IM printing, IM joining of a third party, or the like. If a profile did not exist or if the user wished to change the attributes associated with the profile, the user may select attributes to his or her liking for the content control session to be established with the user of computer 130. The attributes that the user of computer 110 selects control what the user of computer 130 can do with the content generated by the user of computer 110.

It should be understood that although in the preferred embodiment of the invention the program code is implemented in software, in other embodiments of the invention all or portions of the instruction steps executed by these software portions may be resident in firmware or in other program media in connection with one or more computers, which are operative to communicate with end user computer 130 and end user computer 110.

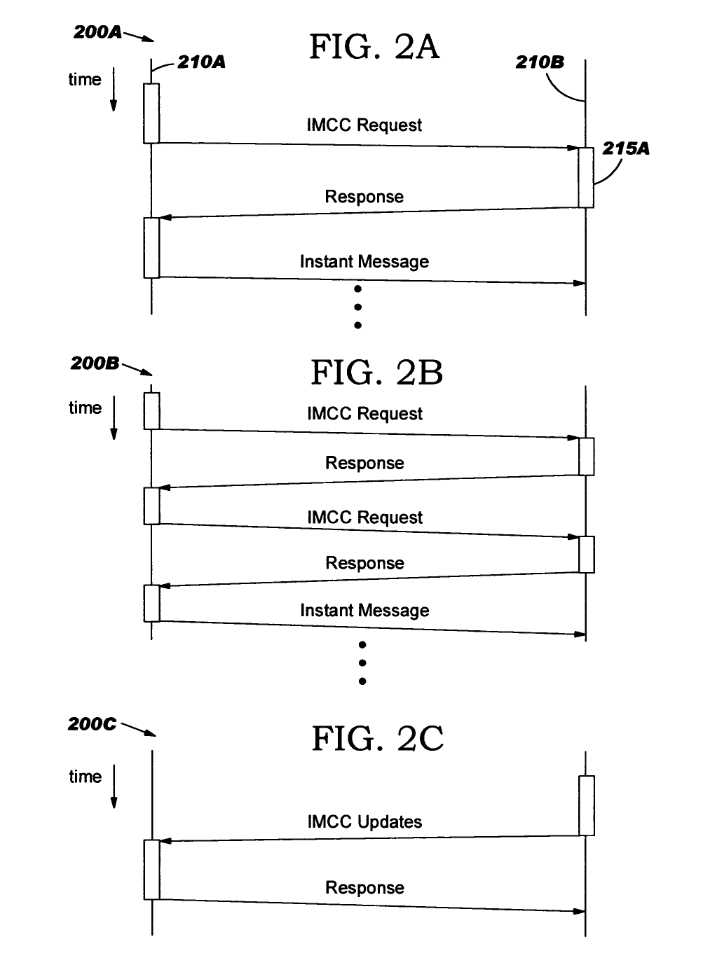

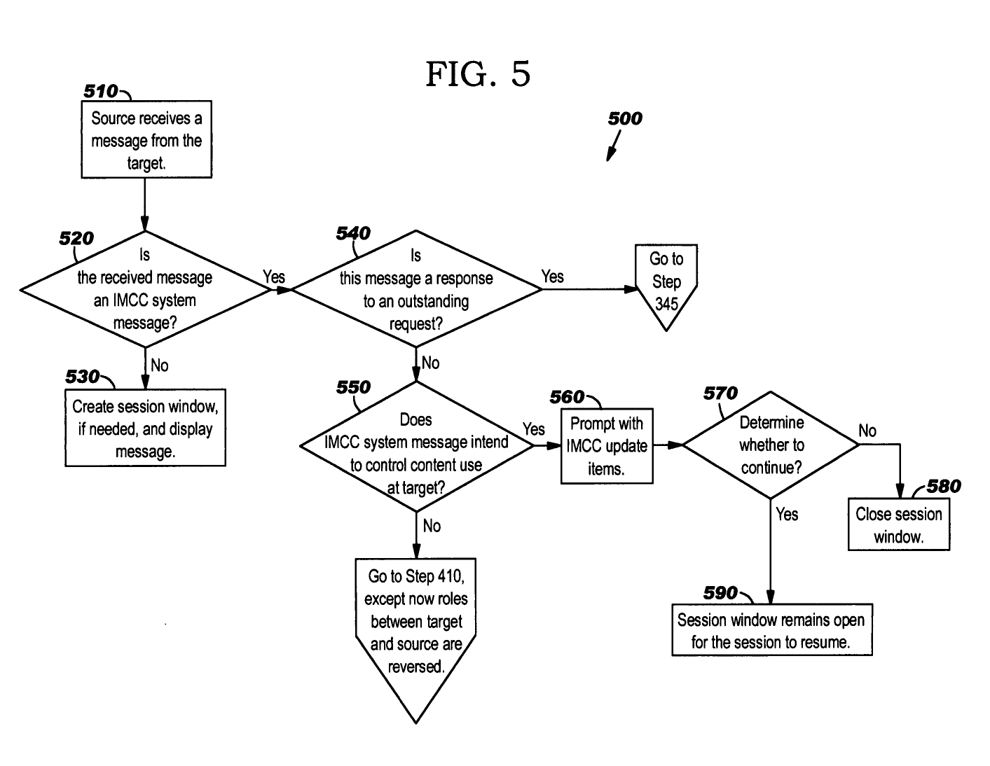

FIGS. 2A-2B illustrate message flows between a source computer and a target computer. Specifically, FIGS. 2A and 2B illustrate exemplary IMCC system message flow timelines for establishing a content control instant messaging session between a source 210A, for example computer 110, and a target 210B, for example computer 130. FIG. 2A illustrates a flow diagram 200A establishing a content control session without negotiation. By way of an example, the source 210A may be the computer used by Joe, an attorney for ABC company. Joe wishes to engage in a content control session with a target 210B. The target 210B may be the computer used by Sara, an employee of ABC company. The term source identifies a party or system controlling the specific content use at a target computer of a content control session. However, it is noted that a computer may take on the role of both the source and target. This situation may occur when each party controls use of content by the other and is described further in connection with the discussion of FIG. 5 below.

Returning to the example, Joe configures his profile 160A for Sara to contain attributes which prevent any content he provides from being printed or screen captured at her computer 130. Joe's system verifies whether Sara's system has an IMCC component 140B and whether the attributes he has configured are supported by Sara's system at the target 210B. It is noted that Sara, and Joe for that matter, may use different computers other than computers 110 and 130. In a preferred embodiment, Joe's system verifies Sara's system each time a content control session is being established to handle the situation of Sara using different computers as might occur if Sara logged in to the same IM service 180 using the same account from another computer system. The IMCC component 140A creates an IMCC request and sends the IMCC request to the target 210B. Special characters contained within the IMCC request may indicate different commands. For example, a “#” character may indicate a system command, the “IMCC” characters may mean an IMCC command, the “A” character may mean check for whether a disabling printing feature is supported at the target's computer, and an “F” may mean check for whether a disabling screen capture feature is supported at the target's computer.

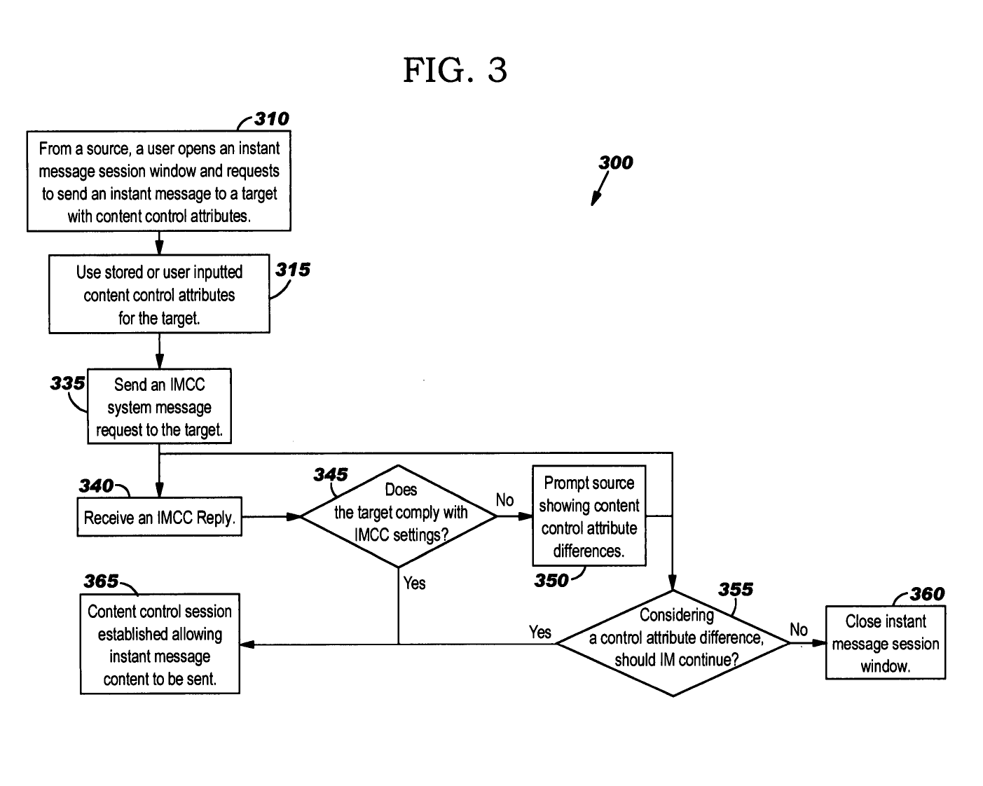

Along with the attributes, a public key may be included with the IMCC request message to allow the target 210B to decode subsequent instant messages sent by the source 210A. Further, using a public key will preclude someone from deploying software which echoes an unauthorized response to indicate compliance with the requested content restriction without actually activating the content restriction on the target. It is recognized by one skilled in the art that different characters may be used to reflect the desired features carried within the IMCC request message and other messages exchanged between the source 210A and target 210B which will be described below. It is recognized and it is contemplated by the present invention that an IMCC request message may be imbedded in a typical instant message. The messages flowing between the source and target may be encrypted to preclude unwanted tapping or interception of the message through the network 120. The method steps for a source are further described below in connection with the discussion of FIG. 3.

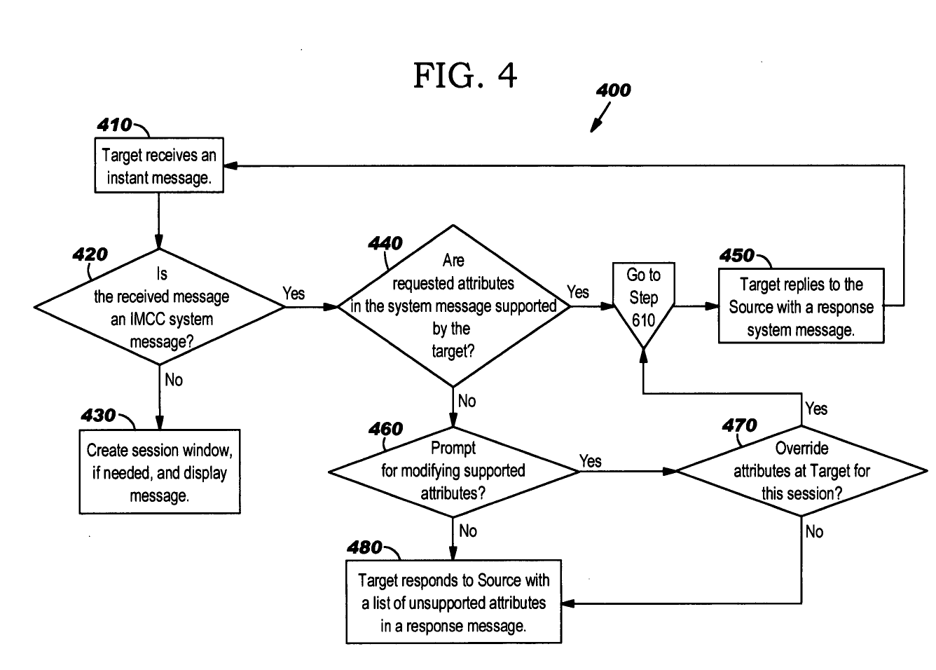

Upon receipt of the IMCC request, the target 210B analyzes the attributes for time 215A within the IMCC request to determine if the requested attributes are supported at the target 210B. The target 210 having an IMCC component 140B parses the attributes and automatically replies with a response message indicating which of the attributes are not supported by target 210B. In addition, Sara having retained Joe's services before may have a profile for Joe in her configuration profile which specifies the content control she requires such as preventing screen capture when revealing content to Joe. Sara's attributes concerning Joe may be included in the response message, a subsequent IMCC request message, or a subsequent update message sent from target 210B. Further, the response message may be encoded with the public key received in the IMCC request message to preclude unwanted tapping of the message over network 120 and to preclude unauthorized responses. The response message may also include Sara's public key with which to encode subsequent messages sent by Joe's system. The method steps for processing a received message at a target are further described below in connection with the discussion of FIG. 4. If the target 210B is determined not to have an IMCC component 140B within a predetermined time, a timer in the source 210A would expire indicating that the request attributes are not supported by the target 210B.

When the source 210A receives the response message, the source 210A determines whether the not supported attributes, if any, carried in the response are important enough to preclude establishment of the content control session. In the example illustrated in FIG. 2A, all the attributes are supported and, thus, the control content session is successfully established. Subsequent instant messages may flow between the source 210A and target 210B with the content control desired by both parties. Joe may now send instant messages to Sara with the assurance that his content cannot be printed or screen captured by Sara. Similarly, Sara may send instant messages to Joe with the assurance that her content cannot be screen captured.

FIG. 2B illustrates a flow diagram 200B for a failed attempt to establish a content control session between two parties with negotiation. Referring to FIG. 2B, the supported attributes and the requested attributes do not match. For example, Sara's computer does not support the disablement of the screen capture feature. The IMCC component 140A prompts Joe to modify his attributes governing the content control session for his content to indicate that disabling screen capture at Sara's computer is not supported. Joe may then accept the limitation on Sara's computer and continue with the conversation or end the conversation altogether. The IMCC component 140A may provide the options to Joe in a pop-up window allowing Joe to modify the attributes associated with Sara's profile. Such modification may be active for the current content control session only or for the current and all subsequent content control sessions initiated by Joe with Sara.

Alternatively, upon a mismatch between requested attributes versus supported attributes, settings in the configuration profile 160A may provide rules to automatically continue if a selected set of attributes were satisfied or quit the session establishment procedure. If Joe responds to the prompt to support a modified attribute, the source 210A sends a notice along with the session identifier in a subsequent IMCC request message allowing the source 210A and the target 210B to negotiate the attributes which define the content control session. The optional second IMCC request message may include the supported settings which the source supports thereby allowing the target to adjust attributes to match the desired control of the content.

FIG. 2C shows a flow diagram 200C the negotiation of attributes of an established content control session between two parties. After the content control session has been established, either party may request modification to the attributes defined for the control of content that apply for the session. FIG. 2C illustrates Sara requesting a change of attributes. For example, she requests that the content she provides should not be allowed to be printed at Joe's computer. During the active session, Sara may effect the change by selecting an icon representing a printer on Joe's computer. The IMCC component 140B would then generate an IMCC update message containing Sara's requested attributes. Joe's computer would reply with a Response in the same manner as described above. The same message flows illustrated in FIG. 2C would apply where the target requests enablement of a disabled feature, for example, if Sara wanted to enable printing at her computer.

FIG. 3 is a flowchart of a method 300 in accordance with the present invention illustrating the role of a source of content for establishing a content control session. At step 310, a user at a source makes a request to send an instant message to a target with content control attributes. Proceeding to step 315, the source uses attributes which are either stored in a configuration profile or inputted by a user. Proceeding to step 335, the IMCC request message is constructed, a timer is set, and the request message is sent by the source to the target. The source waits for either a response to be received or the expiration of the timer.

At optional step 340, the source receives a response. At step 345, the source determines whether the target complies with the requested attributes by looking at the list of unsupported attributes, if any, carried in the response. If any of the attributes are not supported, the method proceeds to optional step 350 where the source prompts the user that differences exist. Step 350 may enforce operation of predefined program rules which range from a least restrictive rule to a strict rule. The least restrictive rule would allow the instant message conversation regardless of whether the supported attributes matched the requested attributes. The strict rule in an unmatched case would require a user at the source to manually provide approval or suggest alternative attributes. The method then proceeds to step 355 to determine whether the instant message session should continue in light of the differences. If the answer is no, then at step 360 the instant message session window would be closed.

Referring back to step 335, if the timer had expired, the method proceeds from step 335 to step 355. Referring back to step 345, if the target complies with the IMCC settings the method proceeds to step 365. Referring back to step 355, if in light of attribute differences described above, the source determines to continue, the method proceeds to step 365. At step 365, a content control session is established thus allowing instant message content to be sent to the target.

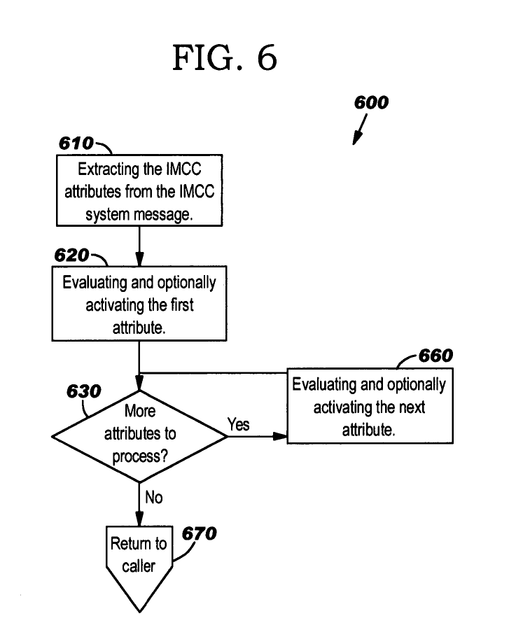

FIG. 4 is a flowchart of a method 400 in accordance with the present invention describing the role of a target of content in determining whether to comply with the attributes defining a requested control session. At step 410, the target receives an instant message. At step 420, the target determines whether the instant message is or contains a content control system message such as an IMCC request or an IMCC update. If the instant message does not contain a system message, the method proceeds to step 430 where a session window is created, if one does not exist, and the content is displayed on the target's screen. If the instant message does contain a system message, the method proceeds to step 440 to determine whether the requested attributes in the system message are supported at the target. If they are, the method 400 iterates through the attributes and activates the same as described in detail in connection with the discussion of FIG. 6. If they are not, the method 400 proceeds to step 460 to determine whether to prompt the target user to modify the requested attributes. Step 460 may enforce either a least restrictive rule or a strict rule as described above. If no prompting is provided, the method proceeds to step 480 where the target responds to the source indicating the list of unsupported attributes at the target. It is recognized and it is contemplated by the present invention that message flows which achieve the same flow of information may vary such as providing multiple response messages where each message contains only one unsupported attribute. It is also recognized and it is contemplated by the present invention that message flows may contain the attributes which are supported at a target.

Returning back to step 460, if the method determines that the user should be prompted to consider modifying an unsupported attribute, the method proceeds to step 470 to determine whether to override attributes at the target and activate those attributes at the target by proceeding to step 610. Otherwise, the method proceeds to step 480 where the target replies in a response message indicating the target's unsupported attributes.

Returning back after the target has iterated and activated the attributes as described in FIG. 6, the method proceeds to step 450 where the target replies to the source with a response message containing the unsupported or unactivated attributes. After step 450, the method proceeds to step 410 to wait for a next message to process.

FIG. 5 is a flowchart of a method 500 in accordance with the present invention addressing the role of a source of content upon receiving an IMCC system message. At step 510, a source receives a message from a target and proceeds to step 520. At step 520, a determination is made whether the received message is or contains an IMCC system message. If it does not, the received message is considered an instant message to be displayed to the source user. Then, the method proceeds to step 530 where a session window is displayed, if necessary. The instant message would be displayed within the session window. If the received message is an IMCC system message, step 520 proceeds to step 540 where a determination is made whether the IMCC system message is a response to an outstanding request. If the received IMCC system message is a response message, the method proceeds to step 345 described in connection with the discussion of FIG. 3.

Otherwise, the method proceeds to step 550 where it determines if the IMCC system message is intending to control the use of content at the target's computer. If the received IMCC system message is intended to control content use at the source machine, the method 500 determines that the initial presumption that the processing computer taking on the role of a source is incorrect. Thus, the method proceeds to step 410 described in connection with the discussion of FIG. 4 where the computer presently operating as a source will change its role to operate as a target to process the content control attributes carried in the IMCC system message.

If the IMCC system message is intended to control the use of content at the target, the method proceeds to step 560 in which the source is prompted with the IMCC update attributes carried in the message. Operation of predefined program rules which range from a least restrictive to a strict rule as described above in FIG. 3 may be enforced in step 560.

At step 560, a determination is also made whether all the requested attributes are supported by the source. Step 560 proceeds to step 570 to determine whether to continue the current content control session with the target. The determination at step 570 may include interaction with the user of the source computer or may programmatically be determined by a configuration setting in the IMCC component described above. Step 570 may also include an evaluation step to activate the requested attributes carried in the IMCC update message. If so, step 570 would include proceeding through the steps defined in FIG. 6 below. If the determination results in not continuing the instant message session, the window session opened at step 310 is closed after appropriately prompting the user at step 580. If the determination results in continuing the instant message session, the window session opened at step 310 remains open as shown at step 590 to continue the session.

FIG. 6 is a flowchart illustrating a method 600 for evaluating and activating IMCC session attributes in accordance with the present invention at the target. At step 610, the attributes carried in an IMCC system message are extracted from the IMCC system message. The method then proceeds to step 620 where the first attribute is evaluated and optionally activated. For example, if the attribute indicated disabling content features associated with an instant messaging application such as suppressing the printing or logging from the instant messaging application, the IMCC component may issue a program function call on the instant messaging application to simply grey out the print or log option controlled by the instant messaging application. By way of another example, if the attribute indicated disabling the print screen or clip board functions, the IMCC component would interact with the operating system since those functions are controlled by the operating system. In so doing, the IMCC component would activate this attribute by issuing a program function call on the operating system to disable the print screen or clip board functions. Alternatively, the IMCC component may inject a program hook in the operating system's keyboard key queue which outputs an input stream of commands on which the operating system acts. Consequently, whenever the user attempts to use an operating system controlled command such as print screen, clip board, or the like, the injected program hook is executed in the IMCC component to intercept the command. For the length of the session, the IMCC component would remove the command from the input stream so that the operating system is precluded from receiving the key sequence corresponding to the print screen or clip board function. Thus, the operating system will not execute the operating system controlled command.

The method then proceeds to step 630 to determine if there exists an additional attribute to process. If there is not, step 630 proceeds to step 670 to return to the function who called this method, for example, method 400. If there is an additional attribute, step 630 proceeds to step 660 where the next attribute is evaluated and optionally activated as described in step 620.

The description of the present invention has been provided for purposes of illustration and description, and is not intended to be exhaustive or as limiting the invention to the embodiment disclosed. Many modifications and variations will be apparent to those of ordinary skill in the art. The present embodiments were chosen and described in order to best explain the principles of the invention, their practical application, and to enable others of ordinary skill in the art to understand the invention. Subject to the limitations of the claims, various embodiments with various modifications as necessary to adapt the present invention to a particular environment or use are hereby contemplated, including without limitation the adaptation of various teachings herein in light of rapidly evolving hardware and software component and techniques.

1. A computer-readable medium whose contents cause a source computer to control the use of content carried over a content controlled instant message session with a target computer, the source computer having a program for performing the steps of:
determining a requested use attribute for instant message content generated by the source computer;
sending the requested use attribute to the target computer;
receiving an indication verifying whether a content controlled instant message session is supported at the target computer; and
establishing the content controlled instant message session having a session use attribute based upon the requested use attribute with the received indication, the content controlled instant message session controlling the use of content provided over the session at the target computer in accordance with the session use attribute.

2. The computer-readable medium of claim 1 wherein the received indication further includes an indication that a use content feature on the target computer corresponding to the requested use attribute has been activated.

3. The computer-readable medium of claim 2 wherein the use content feature is a disabled printing function, a disabled screen capture function, a disabled third party join function, a disabled clipboard copy function, or a disabled logging function at the target computer.

4. The computer-readable medium of claim 1 wherein the establishing step further comprises the steps:
modifying the requested use attribute;
sending the modified use attribute; and
receiving a confirmation of the modified use attribute from the target computer to establish the content controlled instant message session, the session use attribute based upon the modified use attribute;

5. The computer-readable medium of claim 1 further comprising:
updating the session use attribute during communication over the content controlled instant message session after the establishing of the content controlled instant message session step.

6. A computer-readable medium whose contents cause a source computer to control the use of content carried over a content controlled instant message session to a target computer, the target computer having a program for performing the steps of:
receiving a first message containing a first requested use attribute from the source computer;
reading the first requested use attribute;
determining whether a content use feature corresponding to the first requested use attribute is supported on the target computer; and
sending a second message indicating the support of the content use feature to the source computer.

7. The computer-readable medium of claim 6 wherein the program further comprises the step of:
activating the content use feature on the target computer.

8. The computer-readable medium of claim 7 wherein the content use feature is a disabled print function, a disabled screen capture function, a disabled third party join function, a disabled clipboard copy function, or a disabled logging function resident on the target computer.

9. The computer-readable medium of claim 6 wherein the second message includes a first unsupported use attribute, the first unsupported use attribute defining the feature on the target computer which may not be activated.

10. The computer-readable medium of claim 6 wherein the program further comprising the steps of:
determining a second requested use attribute for instant message content generated by the target computer, the second requested use attribute corresponding to a second content use feature;
sending the second requested use attribute to the source computer;
receiving at the source computer an activation indication of the second content use feature; and
sending an instant message having content controlled by the second content use feature.

11. The computer-readable medium of claim 6 further comprising the step of:
updating the first requested use attribute.

12. The computer-readable medium of claim 10 further comprising the step of:
updating the second requested use attribute.

13. A computer-readable medium whose contents cause a computer system to control the use of content over a content controlled instant message session, the computer system having a source computer having a source program and a target computer having a target program, the target program having access to disabling a content use feature on the target computer, by performing the steps of:
sending a requested use attribute for instant message content generated by the source program;
receiving the requested use attribute at the target program;
determining whether a content use feature corresponding to the requested use attribute is supported;
receiving at the source computer an indication of whether the content use feature is supported; and
establishing the content controlled instant message session having a session use attribute defining the content use feature.

14. The computer-readable medium of claim 13 further comprising the step of:
activating the content use feature on the target computer.

15. The computer-readable medium of claim 13 further comprising the following step before the receiving an indication step, the following step comprising:
determining a second requested use attribute to control content sent by the target program.

16. The computer-readable medium of claim 14 wherein the content use feature is a printing function, a screen capture function, a third party join function, a disabled clipboard copy function, or a logging function resident on the target computer.

17. The computer-readable medium of claim 13 further comprising the following steps before the establishing step, the following steps comprising:
modifying the requested use attribute;
sending the modified use attribute to the target computer; and
receiving a confirmation of the modified use attribute from the target computer to establish the content controlled instant message session,
wherein the session use attribute is based upon the modified use attribute;

18. The computer-readable medium of claim 13 further comprising the following step of:
updating the session use attribute after establishment of the content controlled instant message session.

19. A method for controlling the use of content generated by a source computer over a content controlled instant message session to a target computer, the method comprising the steps of:
determining a requested use attribute for instant message content generated by the source computer;
sending the requested use attribute to the target computer;
receiving an indication verifying whether a content controlled instant message session is supported at the target computer; and
establishing the content controlled instant message session having a session use attribute based upon the requested use attribute with the received indication, the content controlled instant message session controlling the use of content provided over the session at the target computer in accordance with the session use attribute.

20. The method of claim 19 wherein the indication further includes an indication that a use content feature on the target computer corresponding to the requested use attribute has been activated.

21. The method of claim 19 wherein the use content feature is a disabled printing function, a disabled screen capture function, a disabled third party join function, a disabled clipboard copy function, or a disabled logging function at the target computer.

22. The method of claim 19 wherein the establishing step further comprises the steps of:
modifying the requested use attribute;
sending the modified use attribute; and
receiving a confirmation of the modified use attribute from the target computer to establish the content controlled instant message session, the session use attribute based upon the modified use attribute.

23. The method of claim 19 further comprising:
updating the session use attribute during communication over the content controlled instant message session after the establishing of the content controlled instant message session step.

24. A method for controlling the use of content generated by a source computer and transmitted over a content controlled instant message session to a target computer, the method at the target computer comprising the steps of:
receiving a first message containing a requested use attribute from the source computer;
reading the requested use attribute;
determining whether a content use feature corresponding to the requested use attribute is supported on the target computer; and
sending a second message indicating the support of the content use feature to the source computer.

25. The method of claim 24 wherein the program further comprises the step of:
activating the content use feature on the target computer.

26. The method of claim 25 wherein the content use feature is a disabled print function, a disabled screen capture function, a disabled third party join function, a disabled clipboard copy function, or a disabled logging function resident on the target computer.

27. The method of claim 24 wherein the second message includes a first unsupported use attribute, the first unsupported use attribute defining the feature on the target computer which may not be activated.

28. The method of claim 24 wherein the program further comprising the step of:
determining a second requested use attribute for instant message content generated by the target computer, the second requested use attribute corresponding to a second content use feature;
sending the second requested use attribute to the source computer;
receiving at the source computer an activation indication of the second content use feature; and
sending an instant message having content controlled by the second content use feature.

29. The method of claim 24 further comprising the step of:
updating the first requested use attribute.

30. The method of claim 28 further comprising the step of:
updating the second requested use attribute.
